(19) United States
(12) Patent Application Publication
(10) Pub. No.: US 2003/0018960 A1
(43) Pub. Date: Jan. 23, 2003

(54) System and a method of sorting perfomance data from one or more system configurations

(76) Inventors: Lance E. Hacking, Portland, OR (US); Tom R. Huff, Portland, OR (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/911,554

(22) Filed: Jul. 23, 2001

(51) Int. Cl. G06F 9/45

(52) U.S. Cl. 717/158

(57) ABSTRACT

A system and a method of sorting performance data for one or more system configurations are provided. Performance data on multiple programs that run on at least one system is obtained. The performance data includes a profile for each program obtained from a tool. The performance data for each profile is automatically sorted to allow for comparison between the profiles.

### FIELD OF THE INVENTION

The invention relates generally to analyzing computer system performance, and more particularly, to a method of sorting execution profiles from one or more system configurations.

### BACKGROUND

Modem computer operating systems have become quite capable and equally complex, with a great deal of interdependency between the various resources that are managed by the operating system. Such resource management can include task priority, the allocation of memory, distribution of programs and data between disk/main memory/cache, spooling, and many others. As a result, much effort has been put into getting the maximum performance out of a system by monitoring the system and adjusting various parameters to improve the performance parameters that are considered more important in that particular system In a related activity, application developers conduct similar optimization efforts to maximize performance in their application programs. These optimization efforts are generically known as system tuning.

Various types of analysis systems are used to implement system tuning. For example, software writers can collect data on an execution profile (describes where a software application spent time when it was run) by inserting programming code around detailed functions. This would enable the programmer to get a rough idea of time spent at a function level. However, this method would be very tedious for long, complicated programs.

Another possibility may be using a tool instrument that compiles code. For example, many compilers have an option that the compiler may insert a timing routine before every program in the function to collect timing information on the program. However, this causes the program to run very slowly.

Another example includes commercial application such as Intel Corporation's VTune. Vtune is a complete visual tuning environment for Windows developers. VTune reports on central processing unit (CPU) statistics, including CPU time consumed for an application and for operating system components. In addition, greater levels of detail may also be seen. For example, Vtune is capable of listing the application's functions and specific timing information related to each However, VTune, as other methods discussed above, do not allow for comparing and fixing programs run on two different systems.

### BRIEF DESCRIPTION OF THE DRAWINGS

The present invention is illustrated by way of example, and not limitation, in the figures of the accompanying drawings in which:

FIG. 1 illustrates a block diagram of a system to sort performance data for one or more system configurations;

FIG. 2 illustrates a block diagram of one embodiment of a sorter;

FIG. 3 illustrates a diagram of one embodiment of a display;

FIG. 4 illustrates a flow diagram of one embodiment of a process of sorting performance data from one or more system configurations; and

FIG. 5 illustrates an example of one embodiment of a computer system.

### DETAILED DESCRIPTION

A system and a method of sorting performance data for one or more system configurations are described. In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention. Several embodiments are described herein. However, there are other ways that would be apparent to one skilled in the art that may be practiced without specific details.

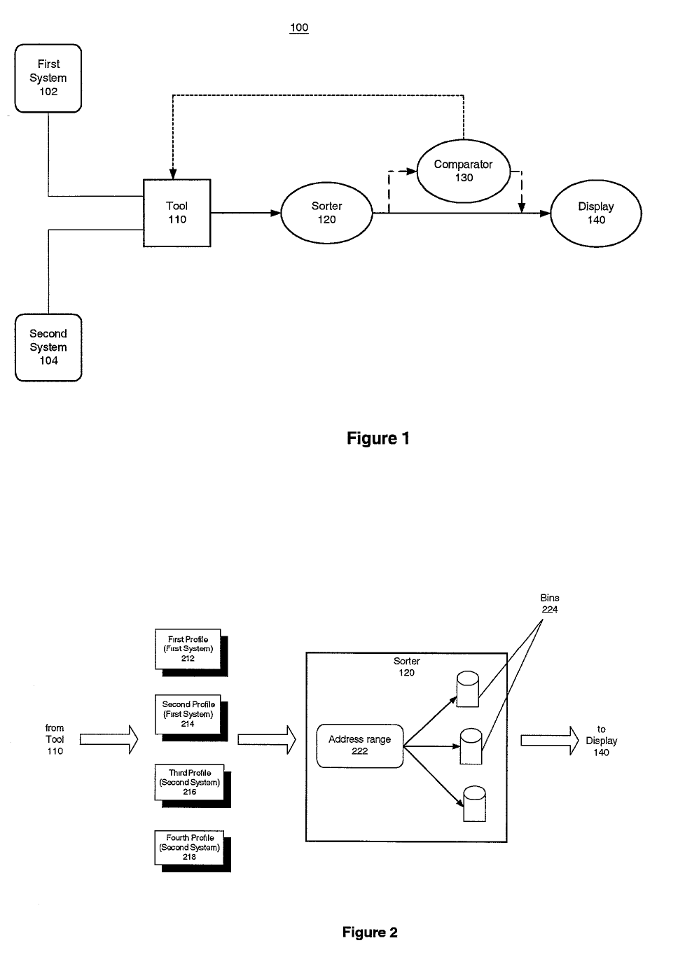

FIG. 1 illustrates a block diagram of a system 100 to sort performance data for one or more system configurations. The system 100 includes a tool 110 that obtains performance data for one or more programs running on a first system 102 and a second system 104.

In one embodiment, the tool 110 includes software code inserted by a software developer around detailed functions so that timing information may be obtained for each of those functions.

In an alternative embodiment, the tool 110 includes a compiler that will automatically insert a timing routine before every function in a program. This type of tool 110 collects timing information for the function as the program runs.

In an alternative embodiment, the tool 110 is Intel Corporation's VTune. VTune is a visual tuning environment for Windows developers. It utilizes a combination of binary instrumentation and time sampling to monitor the performance of many aspects of applications and the Windows operating environment, including device drivers and system dynamic link libraries (DLLs). VTune provides detailed central processing unit (CPU) statistics including CPU time consumed for an application and for operating system components. In addition, individual components may be selected to obtain further detail on. VTune also provides specific timing information related to an application's functions, timing information for each line of source code, and corresponding assembly language statements.

Referring back to FIG. 1, the tool 110 obtains performance data on multiple programs that run on the first system 102. This may include performance data on multiple programs run on a system during a sampling period based on one or more performance counters. In one embodiment, the performance data includes a profile for each program. A profile may be a collection of information that describes where a software application spent time when it was run. Software developers utilize profiles to determine which parts of the software code in a program may be optimized. In one embodiment, the profile may contain data measured based on a performance counter such as clockticks. In alternative embodiments, the performance counter maybe retired instructions or cache misses.

Once the tool 110 obtains the performance data, a sorter 120 automatically sorts the performance data in each profile to allow for comparison between profiles.

In one embodiment, profiles of programs running on the first system 102 are divided into modules and functions for each program, and the performance data is sorted by module and function. Accordingly, a programmer is able to quickly find modules and functions of a program that perform poorly on the first system 102.

In an alternative embodiment, performance data in each profile is divided into bins of programming instructions and sorted by bin. This is shown in FIG. 2. FIG. 2 illustrates a block diagram of one embodiment of a sorter 120. Profiles 212, 214, 216, and 218 are obtained from the tool 110 and feed into the sorter 120. The sorter 120 takes the address range 222 of the program in each profile and divides the address range 222 into a number of bins 224. The bins 224 contain clusters of program instructions. In one embodiment, each bin 224 may contain 128 instructions of the program. In alternative embodiments, bin 224 sizes may vary. The sorted information is then fed into the display 140, shown in FIG. 1. Accordingly, a programmer is able to quickly find software source code regions that perform poorly.

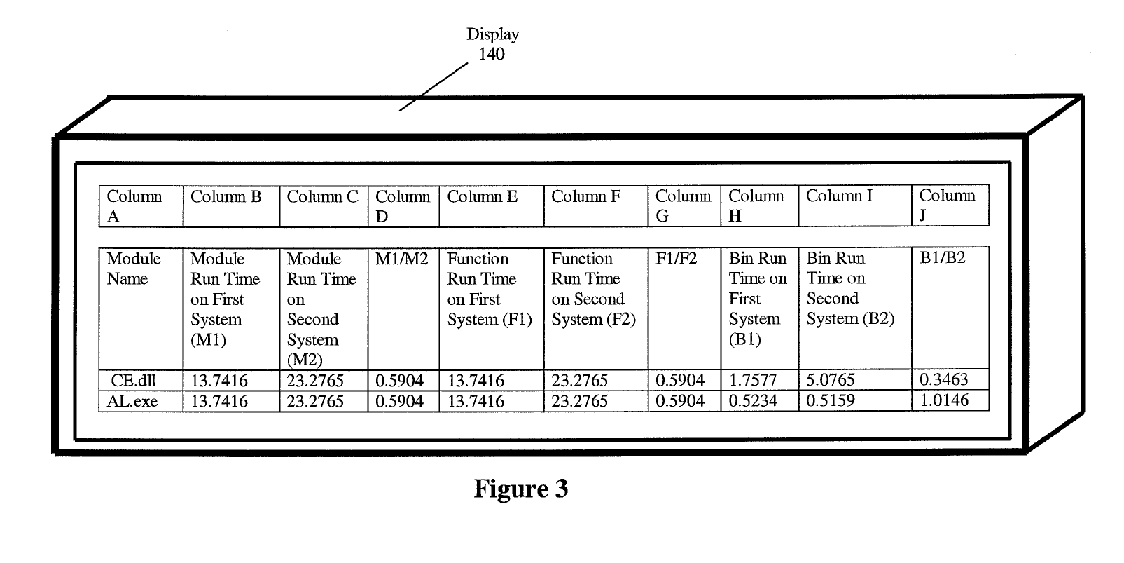

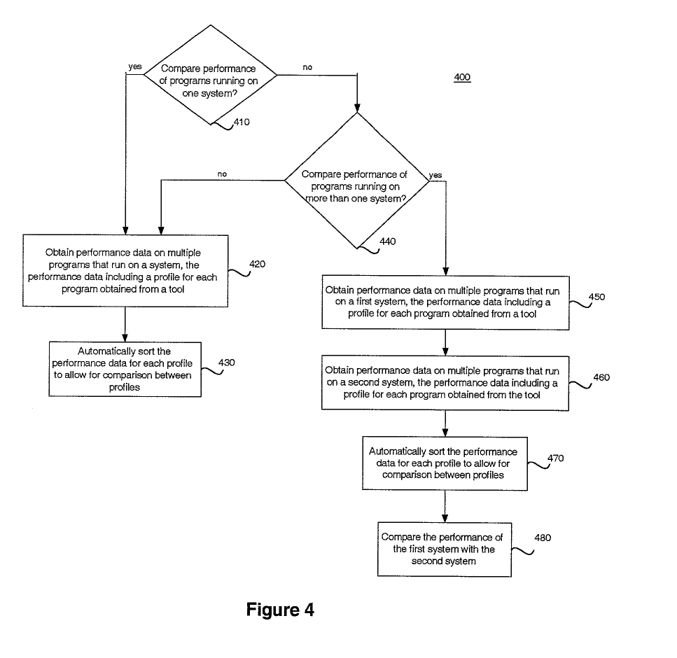

FIG. 3 illustrates a diagram of one embodiment of a display 140. In one embodiment, the sorted information from the sorter 120 is listed in a table format as seen in FIG. 3. Column A of the table lists all the module names of a program Column B lists the performance data obtained from the tool 110, specifically the run time of the module as the program ran on the first systeim Column E lists the run time of each function of a given program on the first system Column H lists the run time of each bin on a first system. In FIG. 4, performance data on a module, function, and bin level is displayed. In alternative embodiments, performance data on other levels may be displayed. In other alternative embodiments, the performance data may not be listed in a table format but in other display formats.

Referring back to FIG. 1, in one embodiment, the tool 110 obtains performance data from the first system 102 and from a second system 104. The sorter 120 then automatically sorts the performance data in each profile to allow for comparison between profiles and between the first system 102 and the second system 104. The performance data includes profiles of each program that ran on the first system 102 and the second system 104.

In one embodiment, after the sorter 120 sorts the performance data, a comparator 130 may compare the performance data of one profile that ran on the first system 102 against the profile that ran on the second system 104. If more performance data is needed, the sorter 120 obtains more performance data, obtained using different performance counters, from the tool 110. The tool 110 sorts the additional performance data and it is sent to the display 140.

In one embodiment, the first and second systems are processors. These two processors may be compared by running different programs on each processor and comparing the performance data from the programs. In one embodiment, a tool such as VTune obtains performance data using a performance counter such as clockticks for a program such as a grammar checker that was run on both a first processor and a second processor. The sorter 120 breaks the program into bins of programing code. A programmer may see the sorted performance data on a display and determine which system runs faster and which areas of the program run faster than others. A programmer may need to use the tool 110 to collect additional performance data to gain insight into the reason for why a program or system may run slow. In one embodiment, after the programmer has determined what type of additional performance data is needed, the tool 110 may be used to obtain this additional performance data. Then, the sorter 120 sorts the performance data, and the sorted data is displayed on the display 140. Accordingly, the programmer is able to quickly identify software source code regions that perform poorly. From this information, the programmer may then go back and fix those regions to better the performance of the program.

Referring back to FIG. 3, the display 140 shows a comparison between performance data of a program run on the first system and the second system The program is divided into modules, CE.dll and AL.exe. Columns B and C indicate the run time of the module being 13.7416 on the first system and 23.2765 seconds on the second system. Column D divides the module run time on the first system by the module run time on the second system which comes to 0.5904. Any number under 1 indicates that the module ran slower on the second system than the first system.

In one embodiment, the same comparison can be made between the systems on a function level as well. Columns B and C indicate the run time of the function being 13.7416 and the run time of the function being 23.2765 on the second system. Column G divides the function run time on the first system by the function run time on the second system, and that comes to 0.5904. Any number under 1 indicates that the function ran slower on the second system than the first system.

In one embodiment, the same comparison can be made between the systems on a bin level as well. Columns H and I indicate the run time of the bin being 1.7577 on the first system and the run time of the bin being 5.0765 on the second system Any number under 1 indicates that the function ran slower on the second system than the first system Accordingly, this type of sorted information allows a programmer to compare profiles of different programs running on one system or multiple systems on a module, function, or bin level. In alternative embodiments, the performance data may be sorted and displayed in other ways.

In one embodiment, a programmer may desire to determine the overall speed of a program after fixing or changing the programming instruction in a certain bin so that the running time of that particular bin is less. For example, if the running time of a bin on the second system is less than the running of that bin on the first system, than that bin may be fixed by that programmer to run faster. In one embodiment, the programmer may want to determine the new running time of the entire program after fixing that particular bin. This may be done by having the sorter 120 substitute the value of the running time of the bin in the second system (which is less) for the running time of the bin on the first system to obtain a new running time for the overall program on the first system. Accordingly, the programmer is then able to determine how much faster the program may run on the first system after fixing that particular bin. In alternative embodiments, this may also be done on a module or function level.

FIG. 4 illustrates a flow diagram of one embodiment of a process 400 of sorting performance data from one or more system configurations. At processing block 410, it is determined if a comparison is to be made between the performance of programs running on one system. If the performance of programs running on one system are to be compared, then the process moves to processing block 420. At processing block 420, performance data on multiple programs that run on a system are obtained. The performance data includes a profile for each program and obtained from a tool. At processing block 430, the performance data of each profile is automatically sorted to allow for comparison between the profiles.

At processing block 440, it is determined if a comparison is to be made of performance of programs running on more than one system. If not, the process moves to processing blocks 420 and 430 as discussed above.

If it is determined that a comparison is to be made of the performance of programs running on one or more systems, than the process moves to processing block 450. At processing block 450, performance data on multiple programs that run on a first system is obtained. The performance data includes a profile for each program run, and the performance data is obtained from a tool. At processing block 460, performance data on multiple programs that run on a second system is obtained. At processing block 470, the performance data for each profile is automatically sorted to allow for comparison between profiles. At processing block 480, the performance of the first system is compared with the performance of the second system.

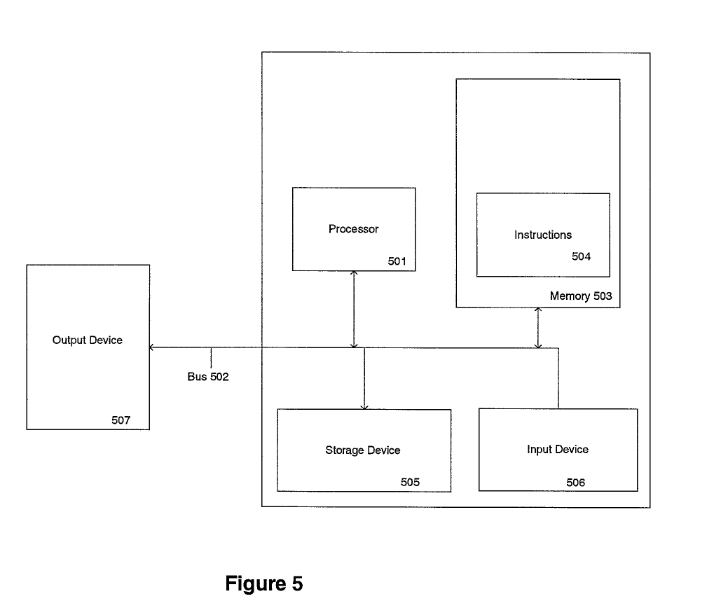

The system and method disclosed herein may be integrated into advanced Internet- or network-based knowledge systems as related to information retrieval, information extraction, and question and answer systems. FIG. 5 illustrates an example of one embodiment of a computer system. The system shown has a processor 501 coupled to a bus 502. Also shown coupled to the bus 502 is a memory 503 which may contain instructions 504. Additional components shown coupled to the bus 502 are a storage device 505 (such as a hard drive, floppy drive, CD-ROM, DVD-ROM, etc.), an input device 506 (such as a keyboard, mouse, light pen, bar code reader, scanner, microphone, joystick, etc.), and an output device 507 (such as a printer, monitor, speakers, etc.). Of course, alternative computer system could have more components than these or a subset of the components listed.

The method described above can be stored in the memory of a computer system (e.g., set top box, video recorders, etc.) as a set of instructions to be executed, as shown by way of example in FIG. 5. In addition, the instructions to perform the method described above could alternatively be stored on other forms of machine-readable media, including magnetic and optical disks. For example, the method of the present invention could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the methods as discussed above, could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

A system and a method of sorting performance data for one or more system configurations have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
obtaining performance data on multiple programs that run on at least one system, the performance data including a first system profile for each program, the performance data obtained from a tool; and
automatically sorting the performance data for each profile to allow for comparison between profiles.

2. The method of claim 1 further comprising:
obtaining performance data on multiple programs that run on a second system, the performance data including a second system profile for each program obtained from the tool; and
automatically sorting the performance data for each profile to allow for comparison between profiles.

3. The method of claim 2 further comprising comparing the performance data of the first system with the second system.

4. The method of claim 3 further comprising:
obtaining additional performance data for both systems using the tool;
automatically sorting the additional performance data of both systems; and
comparing the additional performance data of the first system with the second system.

5. The method of claim 1 wherein obtaining performance data on a number of programs that run on a system comprises:
collecting data on multiple programs run on a system during a sampling period based on performance counters; and
transferring the data to a file.

6. The method of claim 5 wherein one performance counter is clockticks.

7. The method of claim 5 wherein one performance counter is retired instructions.

8. The method of claim 5 wherein one performance counter is cache misses.

9. The method of claim 1 wherein automatically sorting and prioritizing the performance data for each profile to allow for comparison between profiles comprises:
dividing an address range of each program into a number of bins; and
listing the performance data for each bin according to specified criteria.

10. The method of claim 9 wherein the specified criteria is time-based.

11. The method of claim 1 wherein automatically sorting the performance data for each profile to allow for comparison between profiles comprises:
dividing each profile for each program into a number of modules and functions; and
listing the performance data for each module and each function.

12. The method of claim 1 further comprising transferring the sorted data onto a file.

13. The method of claim 1 further comprising displaying the sorted information on a display.

14. The method of claim 1 wherein the performance data profiles include central processing unit (CPU) event measurements.

15. The method of claim 1 wherein the system is a processor.

16. A machine-readable storage medium tangibly embodying a sequence of instructions executable by the machine to perform a method, the method comprising:
obtaining performance data on multiple programs that run on a system, the performance data including a first system profile for each program obtained from a tool; and
automatically sorting the performance data for each profile to allow for comparison between profiles.

17. The machine-readable storage medium of claim 16 wherein the performance data profiles include central processing unit (CPU) event measurements.

18. The machine-readable storage medium of claim 16 wherein the system is a processor.

19. A system comprising:
a tool to obtain performance data on multiple programs that run on at least one system, the performance data including a profile for each program obtained from a tool; and
a sorter to automatically sort the performance data for each profile to allow for comparison between profiles.

20. The system of claim 19 further comprising a comparator to compare the profiles.

21. The system of claim 19 further comprising a display to display the sorted information.

22. The system of claim 19 wherein the performance data profiles includes central processing unit (CPU) event measurements.

23. The system of claim 22 wherein the system is a processor.

24. The system of claim 19 wherein the tool obtains performance data collected according to performance counters.

25. The system of claim 24 wherein one performance counter is clockticks.

26. The system of claim 24 wherein one performance counter is retired instructions.

27. The system of claim 24 wherein one performance counter is cache misses.
